(19) United States
(12) Patent Application Publication
(10) Pub. No.: US 2013/0137470 A1
(43) Pub. Date: May 30, 2013

(54) SYSTEM AND METHOD FOR GENERATING A MESSAGE FOR A CUSTOMER UTILIZING DATA FROM A DATABASE

(71) Applicants: William Edward Schultz, JR., Canton, MI (US); David James Pozniak, JR., White Lake, MI (US)

(72) Inventors: William Edward Schultz, JR., Canton, MI (US); David James Pozniak, JR., White Lake, MI (US)

(73) Assignee: DBIT CONSULTING, INC., Novi, MI (US)

(21) Appl. No.: 13/307,785

(22) Filed: Nov. 30, 2011

(51) Int. Cl. H04W 4/00; G06F 17/30

(52) U.S. Cl. 455/466; 707/758; 707/E17.014

(57) ABSTRACT

A system and a method for generating a message for a customer are provided. The method includes retrieving data associated with a vehicle dealership ID from the first database. The data includes a repair order having a first record having a repair order ID, a repair order status, a customer ID, and the vehicle dealership ID. The data further includes a customer table having a second record including the customer ID, the vehicle dealership ID, and a customer telephone number. The method includes storing the data in a second database, and retrieving the first record from the repair order table in the second database. If the repair order status corresponds to the first order status, the method includes generating a first formatted message, based on the vehicle dealership ID, the customer ID, and the customer telephone number.

### BACKGROUND

Vehicle dealerships offer vehicle repair services. After delivering a vehicle to a dealership for repairs, a vehicle owner may leave the dealership. After a mechanic has examined a vehicle and determined the repair tasks that need to be performed, the vehicle dealership typically attempts to contact the vehicle owner to obtain verbal authorization to perform the repair tasks. Often, the vehicle dealership has difficulty in contacting the vehicle owner which delays the completion of the repair task.

The inventors herein have recognized a need for an improved system and a method for generating a message for a customer of a vehicle dealership that minimizes and/or eliminates the above-mentioned deficiency.

### SUMMARY

A system for generating a message for a customer utilizing data from a first database in accordance with an exemplary embodiment is provided. The system includes a computer configured to retrieve the data associated with a vehicle dealership ID from the first database. The data includes a repair order table and a customer table; the repair order table including a first record having a repair order ID, a repair order status, a customer ID, and the vehicle dealership ID. The customer ID is associated with the customer. The vehicle dealership ID is associated with a vehicle dealership. The customer table has a second record including the customer ID, the vehicle dealership ID, and a customer telephone number. The computer is further configured to store the data in a second database. The computer is further configured to retrieve the first record from the repair order table in the second database. The computer is further configured to compare the repair order status from the first record to a first order status. If the repair order status corresponds to the first order status, the computer is further configured to generate a first formatted message utilizing the vehicle dealership ID, the customer ID, and the customer telephone number.

A method for generating a message for a customer utilizing data from a first database in accordance with another exemplary embodiment is provided. The method includes retrieving the data associated with a vehicle dealership ID from the first database utilizing a computer. The data includes a repair order table and a customer table. The repair order table includes a first record having a repair order ID, a repair order status, a customer ID, and the vehicle dealership ID. The customer ID is associated with the customer. The vehicle dealership ID is associated with a vehicle dealership. The customer table has a second record including the customer ID, the vehicle dealership ID, and a customer telephone number. The method includes storing the data in a second database utilizing the computer. The method further includes retrieving the first record from the repair order table in the second database utilizing the computer. The method further includes comparing the repair order status from the first record to a first order status utilizing the computer. The method further includes if the repair order status corresponds to the first order status then generating a first formatted message utilizing the computer, based on the vehicle dealership ID, the customer ID, and the customer telephone number.

### BRIEF DESCRIPTION OF THE DRAWINGS

FIG. 1 is a block diagram of a system for generating a message for a customer in accordance with an exemplary embodiment;

FIG. 2 is a schematic of a repair order table utilized by the system of FIG. 1,

FIG. 3 is a schematic of a customer table utilized by the system of FIG. 1;

FIG. 4 is a schematic of a sales representative table utilized by the system of FIG. 1;

FIG. 5 is a schematic of an appointment table utilized by the system of FIG. 1;

FIG. 6 is a schematic of a template table utilized by the system of FIG. 1;

FIG. 7 is a schematic of a vehicle dealership table utilized by the system of FIG. 1;

FIG. 8 is a schematic of a parts needed template message utilized by the system of FIG. 1;

FIG. 9 is a schematic of a closed order template message utilized by the system of FIG. 1;

FIG. 10 is a schematic of an open order template message utilized by the system of FIG. 1;

FIG. 11 is a schematic of an appointment template message utilized by the system of FIG. 1;

FIGS. 12-14 is a flowchart of a method for generating a message for a customer in accordance with another exemplary embodiment; and

FIG. 15 is a flowchart of a method for generating an appointment message in accordance with another exemplary embodiment.

### DETAILED DESCRIPTION

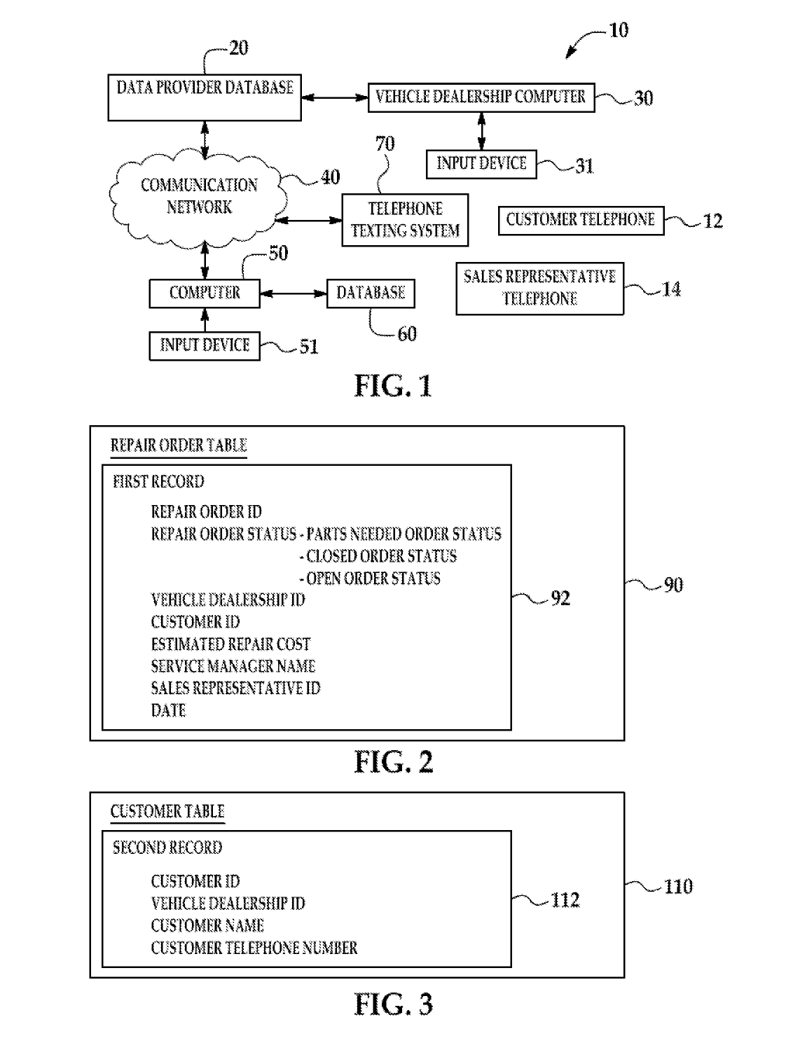

Referring to FIG. 1, a system 10 for generating a message for a customer that is transmitted as a text message to a customer telephone 12 in accordance with an exemplary embodiment is provided. The system 10 also generates a message for a sales representative that is transmitted as a text message to a sales representative telephone 14. The system 10 includes a data provider database 20, a vehicle dealership computer 30, an input device 31, a communication network 40, a computer 50, an input device 51, a database 60, and a telephone texting system 70. For purposes of understanding, the term “ID” means identifier. The term “database” means data stored in a memory device in a computer. The term “computer” means a programmable device designed to perform a sequence of arithmetic operations and/or logical operations. A computer has a microprocessor; and at least one memory device operably coupled to the microprocessor that is configured to store a database, and/or other data, and/or at least one software algorithm. The microprocessor executes the at least one software algorithm corresponding to a sequence of arithmetic operations and/or logical operations.

Referring to FIGS. 1-7, the data provider database 20 is stored in a memory device (not shown) within the vehicle dealership computer 30. The data provider database 20 has data associated with vehicle dealerships, and includes a repair order table 90, a customer table 110, a sales representative table 130, an appointment table 150, a template table 170, and a dealership table 190. The computer 50 periodically accesses and retrieves the data comprising the data provider database 20 from the vehicle dealership computer 30 and stores the data in the database 60.

For purposes of simplicity, referring to FIGS. 2-7, the tables 90, 110, 130, 150, 170, and 190 will be explained below utilizing the information in a single record in each table. However, it should be understood that each of the above tables has a plurality of records therein. For example, the repair order table 90 has a plurality of records corresponding to a plurality of repair orders associated with a plurality of customers, even though only a first record 92 is shown in FIG. 2.

Also, for purposes of simplicity, it is assumed that each portion of information in each illustrated record in each respective table is identical to an identically named portion of information in the other illustrated records in the other tables. In particular, the vehicle dealership ID is present in the records 92, 112, 132, 152, 172, 192 of the tables 90, 110, 130, 150, 170, 190, respectively, and is assumed to have identical information therein for purposes of the discussion below. For example, in the repair order table 90, the record 92 may a vehicle dealership ID of 91234567; and in the customer table 110, the second record 112 may have a vehicle dealership ID of 91234567; and in the sales representative table 130, the third record 132 may have a vehicle dealership ID of 91234567; and in the appointment table 150, the fourth record 152 may have a vehicle dealership ID of 91234567; and in the template table 170, the fifth record 172 may have a vehicle dealership ID of 91234567; and in the dealership table 190, the sixth record 192 may have a vehicle dealership ID of 91234567;

Referring to FIG. 2, the repair order table 90 has a plurality of records associated with a plurality of repair orders generated by the vehicle dealerships. Each record in the repair order table 90 corresponds to a particular repair order associated with a customer. In particular, the repair order table includes a first record 92 associated with a customer. The first record 92 has the following information: (i) repair order ID, (ii) a repair order status, (iii) a vehicle dealership ID, (iv) a customer ID, (v) an estimated repair cost, (vi) a service manager name, (vii) a sales representative ID, and (viii) a date. The repair order ID comprises an alphanumeric or numeric identifier associated with a specific repair order for a customer. The repair order status comprises: (i) a parts needed order status, (ii) a closed order status, or (iii) an open order status. A parts needed order status indicates that parts are needed in order to repair a vehicle. A closed order status indicates that the vehicle repairs are completed. An open order status means that the vehicle repairs have not yet been completed. The vehicle dealership ID comprises an alphanumeric or numeric identifier associated with a vehicle dealership. The customer ID comprises an alphanumeric or numeric identifier associated with a customer. The estimated repair cost comprises a monetary amount that the vehicle dealership will charge the customer for repairing a vehicle. The service manager name comprises alphabetical symbols representing the name of the service manager in the vehicle dealership that is communicating with the customer regarding repairs to the customer's vehicle. The sales representative ID comprises an alphanumeric or numeric identifier associated with a sales representative that sold the vehicle to the customer if applicable. The date comprises alphanumeric information representing a current calendar date.

Referring to FIG. 3, the customer table 110 has a plurality of records associated with a plurality of customers. Each record in the customer table 110 corresponds to a specific customer. In particular, the customer table 110 includes a second record 112 associated with a customer. The second record 112 has the following information: (i) a customer ID, (ii) a vehicle dealership ID, (iii) a customer name, and (iv) a customer telephone number. The customer telephone number corresponds to the telephone number associated with the customer name.

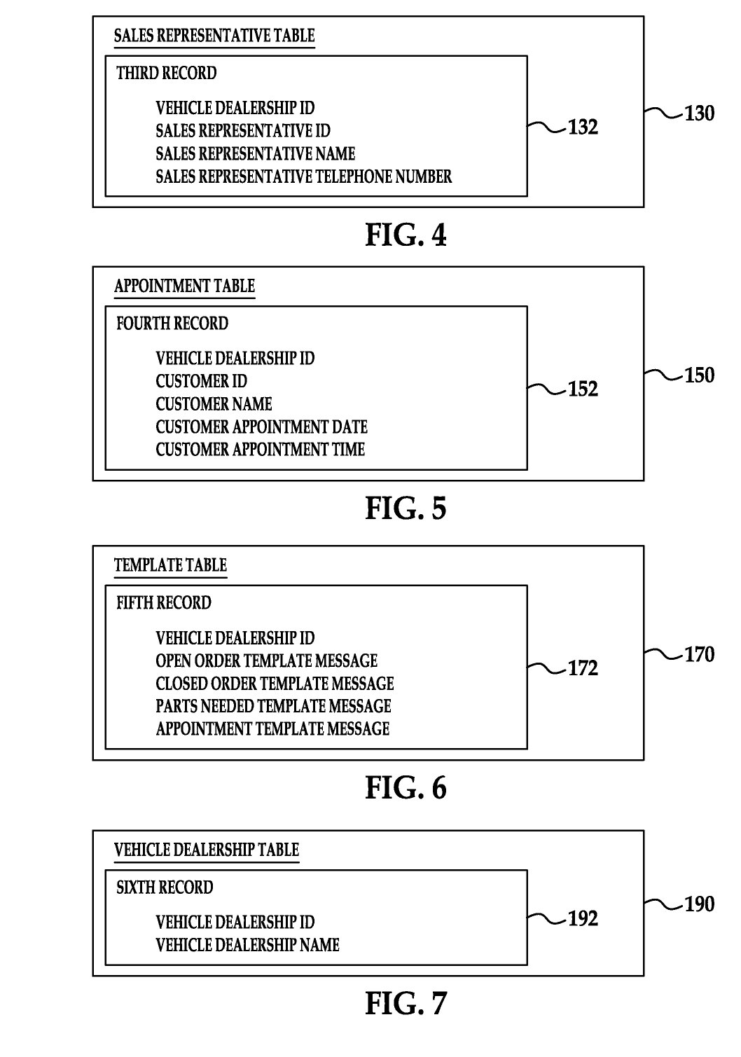

Referring to FIG. 4, the sales representative table 130 has a plurality of records associated with sales representatives at vehicle dealerships. Each record in the sales representative table 130 corresponds to a specific sales representative at a specific vehicle dealership. In particular, the sales representative table 130 includes a third record 132 associated with a sales representative. The third record 132 has the following information: (i) a vehicle dealership ID, (ii) a sales representative ID, (iii) a sales representative name, and (iv) a sales representative telephone number. The sales representative ID is an alphanumeric or numeric identifier associated with a sales representative. The sales representative name is the name of the sales representative. The sales representative telephone number corresponds to the telephone number associated with the sales representative.

Referring to FIG. 5, the appointment table 150 has a plurality of records associated with scheduled repair appointments for customers at vehicle dealerships. Each record in the appointment table 150 corresponds to a specific appointment for a specific customer at a specific vehicle dealership. In one exemplary embodiment, the appointment table 150 includes a fourth record 152. The fourth record 152 has the following information: (i) a vehicle dealership ID, (ii) a customer ID, (iii) a customer name, (iv) a customer appointment date, and (v) a customer appointment time. The customer name is the name of the customer that scheduled an appointment with the vehicle dealership. The customer appointment date is the date on which the customer is scheduled to have a vehicle repair. The customer appointment time is a time in which the customer is to deliver the vehicle to the vehicle dealership.

Referring to FIGS. 6 and 8-11, the template table 170 has a plurality of template messages associated with a specific vehicle dealership for notifying either customers or a sales representative utilizing text messages. Each record in the template table 170 is associated with a specific vehicle dealership. In particular, the template table 170 includes a fifth record 172 associated with a vehicle dealership. The fifth record 172 has the following information: (i) a vehicle dealership ID, (ii) an open order template message, (iii) a closed order template message, (iv) a parts needed template message, and (v) an appointment template message.

Referring to FIG. 10, an exemplary open order template message is an open order template message 230 that is developed and customized by the vehicle dealership utilizing the input device 31 and the vehicle dealership computer 30. The open order template message 230 is utilized to generate a text message that is sent to a sales representative telephone 14 to inform the sales representative that a customer has brought their vehicle in the vehicle dealership for repair, to allow the sales representative to speak to the customer if desired. As shown, the open order template message 230 has the following format: “[customer name] has brought in their car for repair and is in the service waiting room.” The actual customers name is inserted in the data field [customer name] in a text message.

Referring to FIG. 9, an exemplary closed order template message is a closed order template message 220 that is developed and customized by the vehicle dealership utilizing the input device 31 and the vehicle dealership computer 30. The closed order template message 220 is utilized to generate a text message that is sent to a customer to inform the customer that the repairs to their vehicle have been completed. As shown, the closed order template message 220 has the following format: “Your vehicle is ready for pickup. The total repair cost is [estimated repair cost]. Please see [service manager ID] at the customer counter.” The estimated repair costs is inserted in the data field [estimated repair cost]; and the service manager ID is inserted in the data field [service manager ID], in a text message.

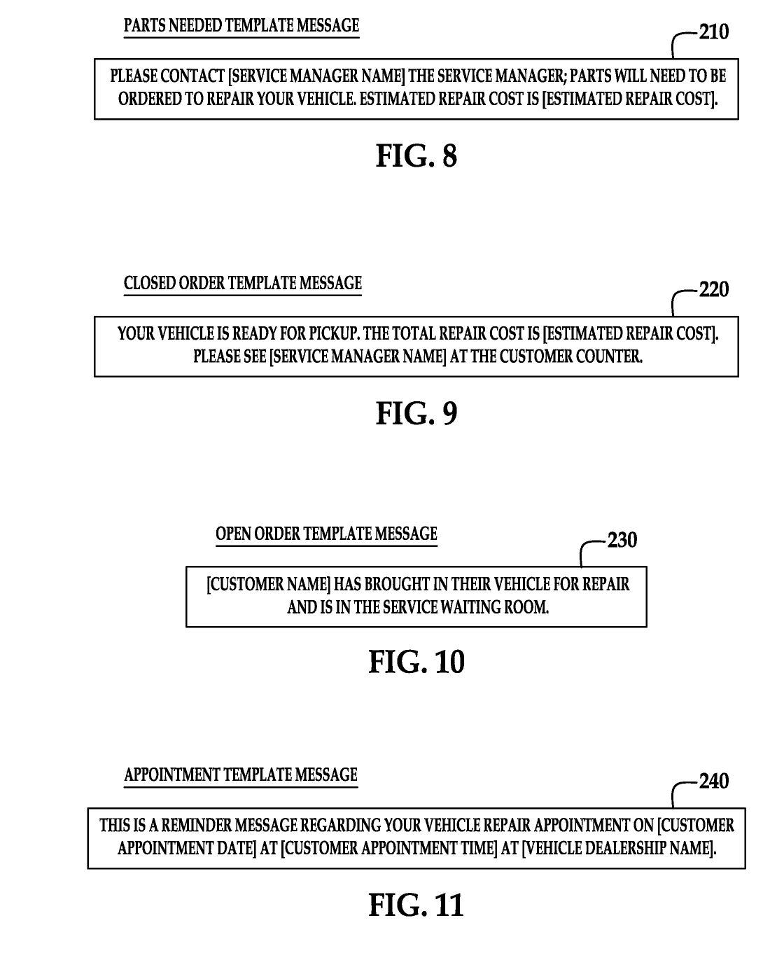

Referring to FIG. 8, an exemplary parts needed template message is a parts needed template message 210 that is developed and customized by the vehicle dealership utilizing the input device 31 and the vehicle dealership computer 30. The parts needed template message 210 is utilized to generate a text message that is sent to a customer to inform the customer that the parts will need to be ordered to repair their vehicle. As shown, the parts needed template message 210 has the following format: “Please contact [service manager name] the service manager; parts will need to be ordered to repair your vehicle. Estimated repair cost is [estimated repair cost].” The service manager name is inserted in the data field [service manager name]; and the estimated repair cost is inserted in the data field [service manager name], in a text message.

Referring to FIG. 11, an exemplary appointment template message is an appointment template message 240 that is a customized message developed by the vehicle dealership utilizing the input device 31 and the vehicle dealership computer 30. The appointment template message 240 is utilized to generate a text message that is sent to a customer to inform the customer of a scheduled repair appointment to repair their vehicle. As shown, the appointment template message 240 has the following format: “This is a reminder message regarding your vehicle repair appointment on [customer appointment date] at [customer appointment time] at [dealership name].” The customer appointment date is inserted in the data field [customer appointment date]; and the customer appointment time is inserted in the data field [customer appointment time]; and the vehicle dealership name is inserted in the data field [dealership name] in a text message.

Referring to FIG. 7, the dealership table 190 has a plurality of records associated with a vehicle dealership, and each record in the dealership table 190 corresponds to a specific vehicle dealership. In particular, the dealership table 190 includes a sixth record 192 associated with a vehicle dealership. The sixth record 192 has the following information: (i) vehicle dealership ID and (ii) vehicle dealership name.

Referring to FIGS. 1 and 8-11, the vehicle dealership computer 30 is configured to communicate with the data provider database 20 and to allow the vehicle dealership to develop and store the template messages in the database 20 utilizing the input device 31 and the vehicle dealership computer 30. The template messages include: the open order template message 230, the closed order template message 220, the parts needed template message 210, the appointment template message 240, and the fifth record 172 of the template table 170. The vehicle dealership computer 30 is further operably coupled to the input device 31. In one exemplary embodiment, the vehicle dealership computer 30 has a microprocessor (not shown) operably coupled to a memory device (not shown) that stores the data provider database 20 therein.

The computer 50 is configured to access the data provider database 20 and a telephone texting system 70 utilizing the communication network 40 as will be explained in greater detail below. The computer 50 is further configured to access the database 60 and to communicate with the input device 50. The computer 50 is configured to periodically retrieve the data corresponding to the data provider database 20 including the associated tables and template messages and to store the data in the database 60. In one exemplary embodiment, the computer 50 has a microprocessor (not shown) operably coupled to a memory device (not shown) that stores the database 60 therein.

The telephone texting system 70 is configured to receive a formatted message from the computer 50 utilizing the communication network 40, and to generate a text message based upon the formatted message. The telephone texting system 70 may transmit the text message over a wireless communication network or a hardwired communication network, or a combination thereof, to either the customer telephone 12 or the sales representative telephone 14.

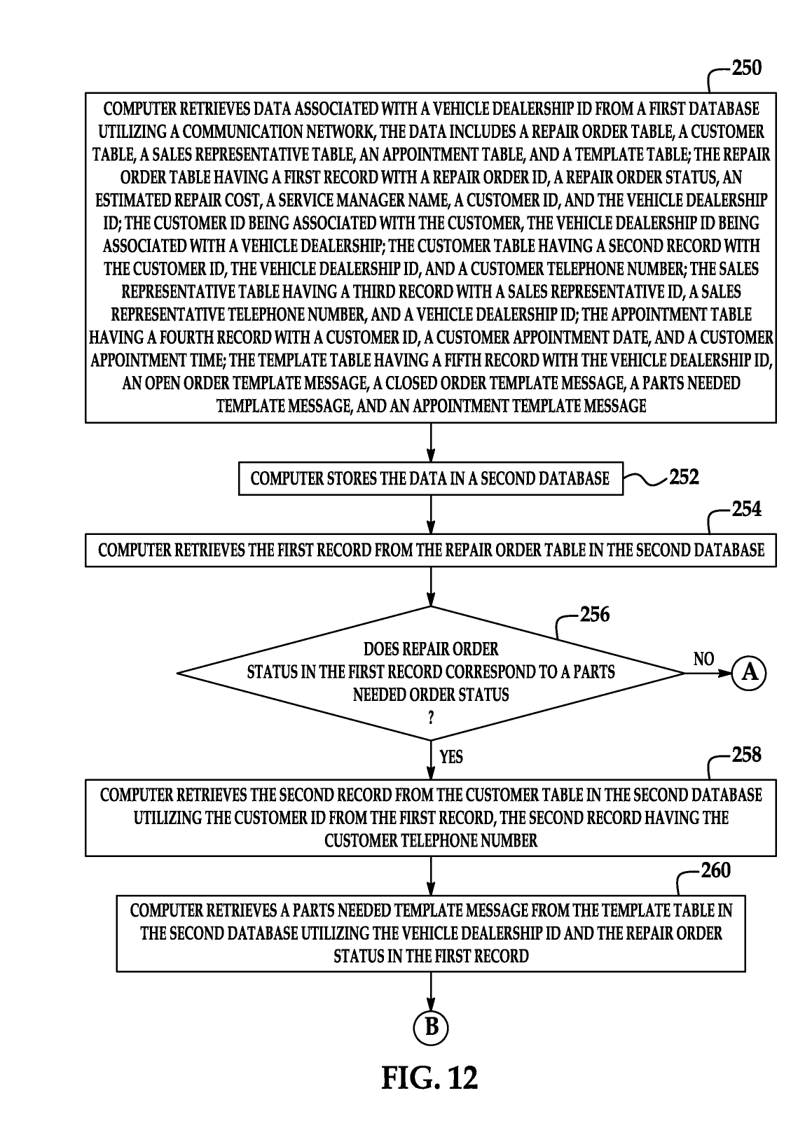

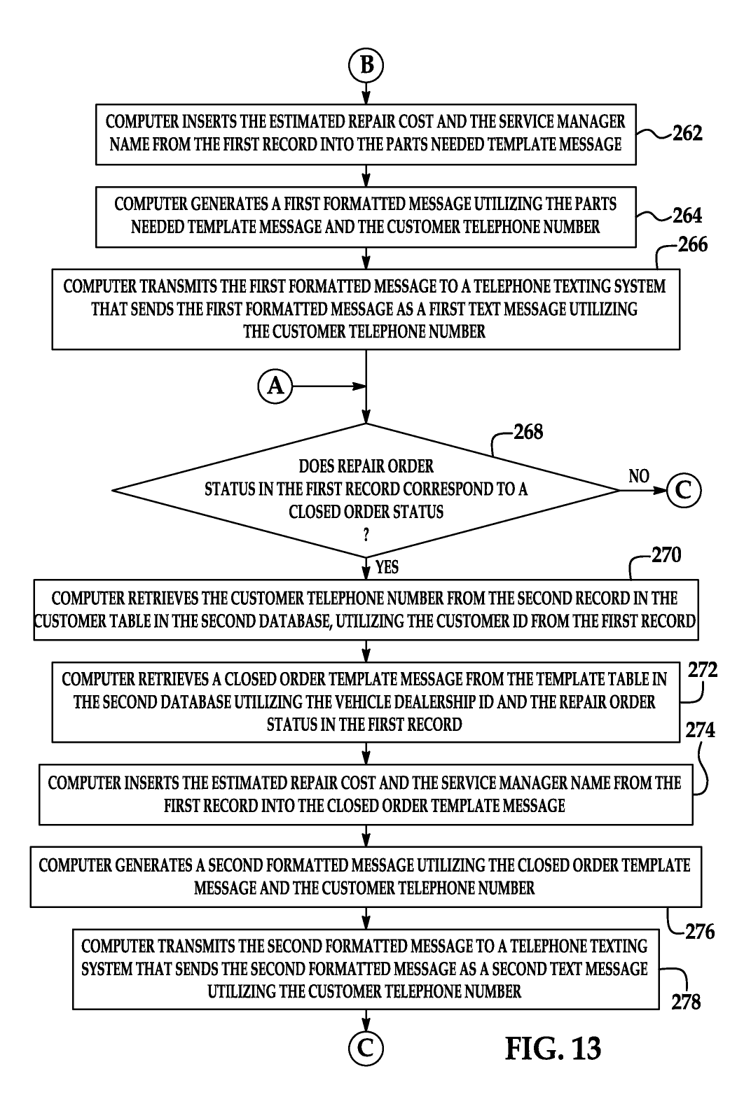

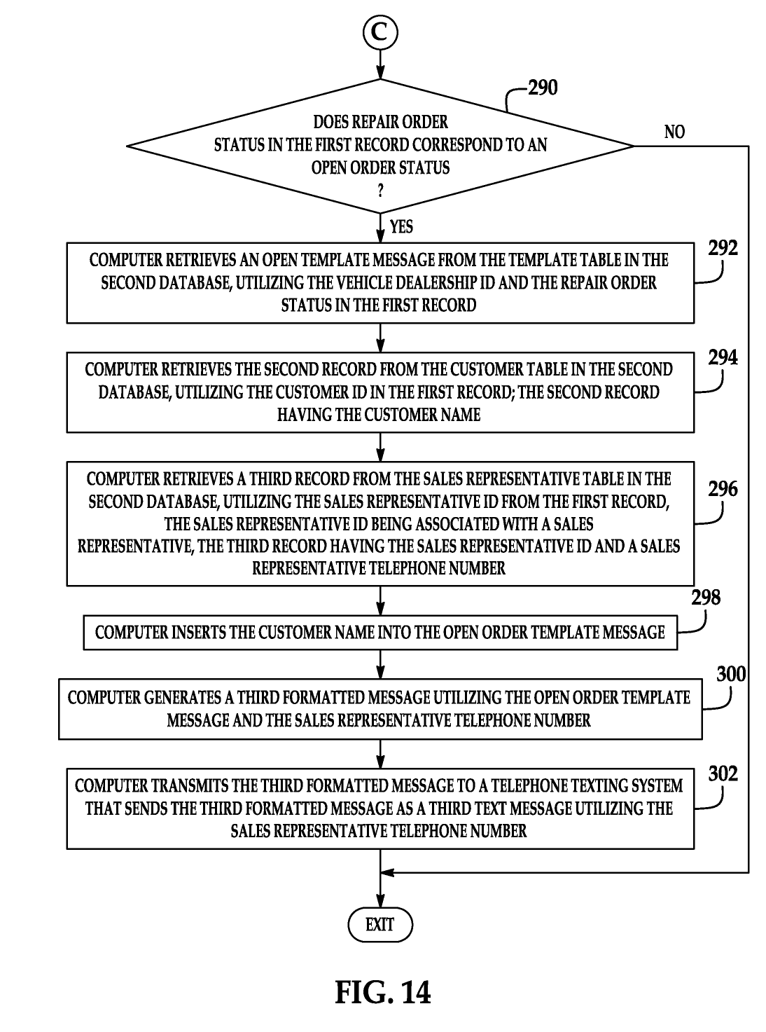

Referring to FIGS. 1 and 12-14, a flowchart of a method for generating a message for a customer utilizing data from the data provider database 20 in accordance with an exemplary embodiment will now be explained.

At step 250, the computer 50 retrieves data associated with a vehicle dealership ID from a first database 20 utilizing the communication network 40. The data includes the repair order table 90, the customer table 110, the sales representative table 130, the appointment table 150, and the template table 170. The repair order table 90 has a first record with a repair order ID, a repair order status, an estimated repair cost, a service manager name, a customer ID, and the vehicle dealership ID. The customer ID is associated with the customer. The vehicle dealership ID is associated with a vehicle dealership. The customer table 110 has the second record 112 with the customer ID, the vehicle dealership ID, and a customer telephone number. The sales representative table 130 has the third record 132 with a sales representative ID, a sales representative telephone number, and a vehicle dealership ID. The appointment table 150 has the fourth record 152 with a customer ID, a customer appointment date, and a customer appointment time. The template table 170 has the fifth record 172 with the vehicle dealership ID, the open order template message 230, the closed order template message 220, the parts needed template message 210, and the appointment template message 240. After step 250, the method advances to step 252.

At step 252, the computer 50 stores the data in the second database 60. After step 252, the method advances to step 254.

At step 254, computer 50 retrieves the first record 92 (shown in FIG. 2) from the repair order table 90 in the second database 60. After step 254, the method advances to step 256.

At step 256, the computer 50 makes a determination as to whether the repair order status in the first record 92 correspond to a parts needed order status. If the value of step 256 equals “yes”, the method advances step 258. Otherwise, the method advances to step 268.

At step 258, computer 50 retrieves the second record 112 from the customer table 110 (shown in FIG. 3) in the second database 60 utilizing the customer ID from the first record 92. The second record 112 has the customer telephone number. After step 258, the method advances to step 260.

At step 260, computer 50 retrieves the parts needed template message 210 shown in FIG. 8) from the template table 170 (shown in FIG. 6) in the database 60 utilizing the vehicle dealership ID and the repair order status in the first record 92. After step 260, the method advances to step 262.

At step 262, the computer 50 inserts the estimated repair cost and the service manager name from the first record 92 into the parts needed template message 210. After step 262, the method advances to step 264.

At step 264, the computer 50 generates a first formatted message utilizing the parts needed template message 210 and the customer telephone number. After step 264, the method advances to step 266.

At step 266, the computer 50 transmits the first formatted message to the telephone texting system 70 that sends the first formatted message as a first text message utilizing the customer telephone number. In particular, the first text message is transmitted to the customer telephone 12 utilizing the customer telephone number and is displayed on a display screen of the customer telephone 12. After step 266, the method advances to step 268.

At step 268, the computer 50 makes a determination as to whether the repair order status in the first record 90 corresponds to a closed order status. If the value of step 268 equals “yes”, the method advances to step 270. Otherwise, the method advances to step 290.

At step 270, the computer 50 retrieves the customer telephone number from the second record 112 (shown in FIG. 3) in the customer table 110 in the database 60, utilizing the customer ID from the first record 92 (shown in FIG. 2). After step 270, the method advances to step 272.

At step 272, the computer 50 retrieves the closed order template message 220 (shown in FIG. 9) from the template table 170 (shown in FIG. 6) in the database 60 utilizing the vehicle dealership ID and the repair order status in the first record 92. After step 272, the method advances to step 274.

At step 274, the computer 50 inserts the estimated repair cost and the service manager name from the first record 92 into the closed order template message 220. After step 274, the method advances to step 276.

At step 276, the computer 50 generates a second formatted message utilizing the closed order template message 220 and the customer telephone number. After step 276, method advances step 278.

At step 278, the computer 50 transmits the second formatted message to the telephone texting system 70 that sends the second formatted message as a second text message utilizing the customer telephone number. In particular, the second text message is transmitted to the customer telephone 12 utilizing the customer telephone number and is displayed on a display screen of the customer telephone 12. After step 278, the method advances to step 290.

At step 290, the computer 50 makes a determination as to whether the repair order status in the first record 92 corresponds to an open order status. If the value of step 290 equals “yes”, the method advances to step 292. Otherwise, the method is exited.

At step 292, the computer 50 retrieves the open order template message (shown in FIG. 10) from the template table 170 (shown in FIG. 6) in the database 60, utilizing the vehicle dealership ID and the repair order status in the first record 92 (shown in FIG. 2). After step 292, the method advances to step 294.

At step 294, the computer 50 retrieves the second record 112 (shown in FIG. 3) from the customer table 110 (shown in FIG. 3) in the database 60, utilizing the customer ID in the first record 92. The second record 112 has the customer name. After step 294, the method advances to step 296.

At step 296, computer 50 retrieves the third record 132 (shown in FIG. 4) from the sales representative table 130 (shown in FIG. 4) in the database 60, utilizing the sales representative ID from the first record 92. The third record has the sales representative ID, and a sales representative telephone number. The sales representative ID is associated with a sales representative.

At step 298, the computer 50 inserts the customer name into the open order template message 230. After step 298, the method advances to step 300.

At step 300, the computer 50 generates a third formatted message utilizing the open order template message 230 and the sales representative telephone number. After step 300, method advances to step 302.

At step 302, the computer 50 transmits the third formatted message to the telephone texting system 70 that sends the third formatted message as a third text message utilizing the sales representative telephone number. In particular, the third text message is transmitted to the customer telephone 12 utilizing the customer telephone number and is displayed on a display screen of the customer telephone 12. After step 302, the method is exited.

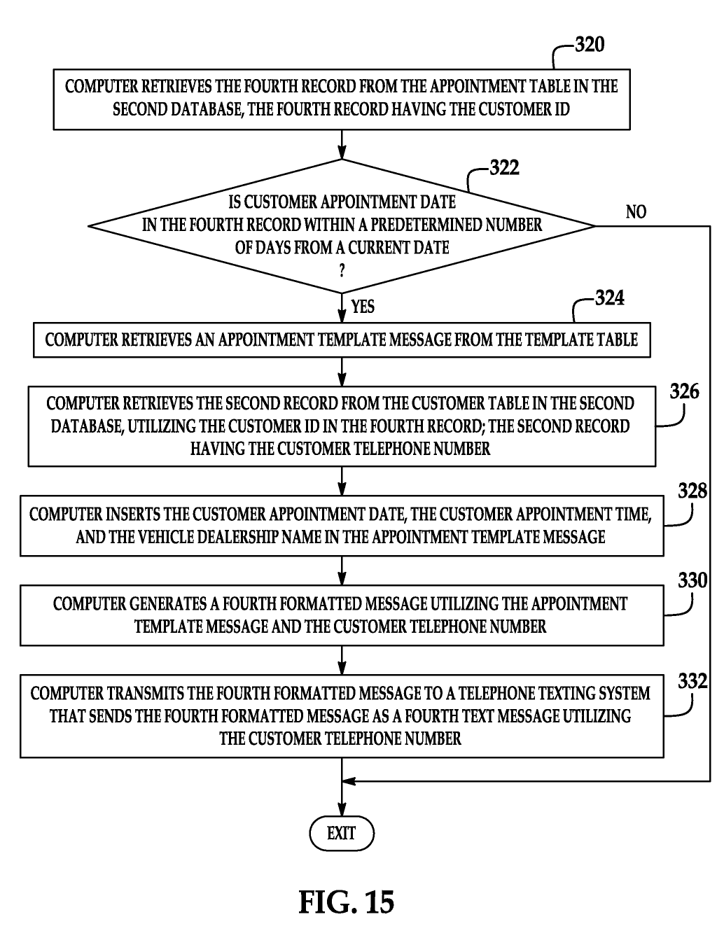

Referring to FIGS. 1 and 15, a flowchart of another method for generating a message for a customer utilizing data from the data provider database 20 in accordance with another exemplary embodiment will now be explained.

At step 320, the computer 50 retrieves the fourth record 152 (shown in FIG. 5) from the appointment table 150 (shown in FIG. 150) in the second database 60. The fourth record 152 has the customer ID. After step 320, the method advances to step 322.

At step 322, the computer 50 makes a determination as to whether the customer appointment date in the fourth record is within a predetermined number of days from a current date. If the value of step 322 equals “yes”, the method advances to step 324. Otherwise, the method is exited.

At step 324, computer 50 retrieves the appointment template message 240 (shown in FIG. 11) from the template table 170 (shown in FIG. 6). After step 324, the method advances to step 326.

At step 326, the computer 50 retrieves the second record 112 (shown in FIG. 3) from the customer table 110 in the second database utilizing the customer ID in the fourth record 152. The second record 112 has the customer telephone number. After step 326, the method advances to step 328.

At step 328, the computer 50 inserts the customer appointment date, the customer appointment time, and the vehicle dealership name in the appointment template message 240. After step 328, method advances to step 330.

At step 330, the computer 50 generates a fourth formatted message utilizing the appointment template message 240 and the customer telephone number. After step 330, the method advances step 332.

At step 332, computer 50 transmits the fourth formatted message to the telephone texting system 70 that sends the fourth formatted message as a fourth text message utilizing the customer telephone number. In particular, the fourth text message is transmitted to the customer telephone 12 utilizing the customer telephone number and is displayed on a display screen of the customer telephone 12. After step 332, the method is exited.

The system 10 and the method for generating a message for a customer utilizing data from a database provide a substantial advantage over other systems and methods. In particular, the system 10 and the method generate a formatted message based on information in a repair order table in order to notify customers regarding vehicle repairs.

While the claimed invention has been described in detail in connection with only a limited number of embodiments, it should be readily understood that the invention is not limited to such disclosed embodiments. Rather, the claimed invention can be modified to incorporate any number of variations, alterations, substitutions or equivalent arrangements not heretofore described, but which are commensurate with the spirit and scope of the invention. Additionally, while various embodiments of the claimed invention have been described, it is to be understood that aspects of the invention may include only some of the described embodiments. Accordingly, the claimed invention is not to be seen as limited by the foregoing description.

What is claimed is:

1. A system for generating a message for a customer utilizing data from a first database, comprising:
a computer configured to retrieve the data associated with a vehicle dealership ID from the first database; the data including a repair order table and a customer table; the repair order table including a first record having a repair order ID, a repair order status, a customer ID, and the vehicle dealership ID;
the customer ID being associated with the customer, the vehicle dealership ID being associated with a vehicle dealership; the customer table having a second record including the customer ID, the vehicle dealership ID, and a customer telephone number;
the computer further configured to store the data in a second database;
the computer further configured to retrieve the first record from the repair order table in the second database; and
the computer further configured to compare the repair order status from the first record to a first order status, and if the repair order status corresponds to the first order status the computer further configured to generate a first formatted message utilizing the vehicle dealership ID, the customer ID, and the customer telephone number.

2. The system of claim 1, wherein:
the computer is further configured to retrieve the second record from the customer table in the second record utilizing the customer ID from the first record, the second record having the customer telephone number;
the computer further configured to retrieve a first template message from a template table in the second database utilizing the vehicle dealership ID and the repair order status in the first record; and
the computer further configured to generate the first formatted message utilizing the first template message and the customer telephone number.

3. The system of claim 2, wherein the first record in the repair order table further includes an estimated repair cost; and
if the first order status in the first record comprises a parts needed order status, the computer configured to retrieve the first template message corresponding to a parts needed template message from the template table, and the computer further configured to insert the estimated repair cost into the first template message.

4. The system of claim 3, wherein the first record in the repair order table further includes a service manager name, and
if the first order status in the first record comprises the parts needed order status, the computer further configured to insert the service manager name into the first template message, the service manager name being associated with a service manager at the vehicle dealership.

5. The system of claim 2, wherein the first record in the repair order table further includes an estimated repair cost; and
if the first order status in the first record comprises a closed order status, the computer configured to select the first template message corresponding to a closed order template message, the computer further configured to insert the estimated repair cost into the first template message.

6. The system of claim 5, wherein the first record in the repair order table further includes a service manager name, and
if the first order status in the first record comprises the closed order status, the computer further configured to insert the service manager name into the first template message.

7. The system of claim 1, wherein the data in the second database further includes a sales representative table having a third record with the vehicle dealership ID and a sales representative telephone number, the system further comprising:
if the first order status in the first record comprises an open order status, the computer further configured to retrieve an open order template message from the template table in the second database, utilizing the vehicle dealership ID;
the computer further configured to retrieve the second record from the customer table in the second database utilizing the customer ID in the first record, the second record having the customer name;
the computer further configured to retrieve the third record from the sales representative table in the second database, utilizing a sales representative ID from the first record, the third record having a sales representative telephone number, the sales representative ID being associated with a sales representative;
the computer further configured to insert the customer name into the open order template message;
the computer further configured to generate a second formatted message utilizing the sales representative telephone number and the open order template message; and
the computer further configured to transmit the second formatted message such that the second formatted message is directed to the sales representative.

8. The system of claim 1, wherein the data in the second database further includes an appointment table having a third record with a customer ID, a customer appointment date, and a customer appointment time;
the computer further configured to retrieve the third record from the appointment table in the second database utilizing the customer ID;
the computer is further configured to retrieve the second record from the customer table in the second database utilizing the customer ID from the first record, the second record having the customer telephone number;
if the customer appointment date is within a predetermined number of days from a current date, then:
the computer configured to retrieve an appointment template message from the template table in the second database;
the computer further configured to insert the customer appointment date, the customer appointment time, and the vehicle dealership ID into the appointment template message; and
the computer further configured to generate the second formatted message utilizing the appointment template message and the customer telephone number.

9. The system of claim 1, wherein the first order status comprises at least one of: an open order status associated with the customer initially bringing a vehicle into the vehicle dealership for service, a closed order status associated with the vehicle being ready for customer pickup, and a parts needed order status associated with parts being needed to repair the vehicle.

10. The system of claim 1, wherein the computer is further configured to transmit the first formatted message to a telephone texting system.

11. The system of claim 10, wherein the first formatted message is sent as a text message from the telephone texting system utilizing the customer telephone number.

12. A method for generating a message for a customer utilizing data from an first database, comprising:
retrieving the data associated with a vehicle dealership ID from the first database utilizing a computer; the data including a repair order table and a customer table; the repair order table including a first record having a repair order ID, a repair order status, a customer ID, and the vehicle dealership ID; the customer ID being associated with the customer, the vehicle dealership ID being associated with a vehicle dealership; the customer table having a second record including the customer ID, the vehicle dealership ID, and a customer telephone number;
storing the data in a second database utilizing the computer;
retrieving the first record from the repair order table in the second database utilizing the computer; and
comparing the repair order status from the first record to a first order status utilizing the computer, and if the repair order status corresponds to the first order status then generating a first formatted message utilizing the computer, based on the vehicle dealership ID, the customer ID, and the customer telephone number.

13. The method of claim 12, further comprising:
retrieving the second record from the customer table in the second database utilizing the customer ID from the first record, utilizing the computer, the second record having the customer telephone number;
retrieving a first template message from a template table in the second database utilizing the vehicle dealership ID and the repair order status in the first record, utilizing the computer; and
generating the first formatted message utilizing the first template message and the customer telephone number, utilizing the computer.

14. The method of claim 13, wherein the first record in the repair order table further includes an estimated repair cost; the method further comprising:
if the first order status in the first record comprises a parts needed order status, then retrieving the first template message corresponding to a parts needed template message from the template table utilizing the computer, and inserting the estimated repair cost into the first template message utilizing the computer.

15. The method of claim 14, wherein the first record in the repair order table further includes a service manager name; the method further comprising:
if the first order status in the first record comprises the parts needed order status, then inserting the service manager name into the first template message utilizing the computer, the service manager name being associated with a service manager at the vehicle dealership.

16. The method of claim 13, wherein the first record in the repair order table further includes an estimated repair cost; the method further comprising:
if the first order status in the first record comprises a closed order status, then selecting the first template message corresponding to a closed order template message utilizing the computer, and inserting the estimated repair cost into the first template message utilizing the computer.

17. The method of claim 16, wherein the first record in the repair order table further includes a service manager name; the method further comprising:
if the first order status in the first record comprises the closed order status, then inserting the service manager name into the first template message utilizing the computer.

18. The method of claim of claim 12, wherein the data in the second database further includes a sales representative table having a third record with the vehicle dealership ID and a sales representative telephone number, the method further comprising:
if the first order status in the first record comprises an open order status, then retrieving an open order template message from the template table in the second database utilizing the vehicle dealership ID, utilizing the computer;
retrieving the second record from the customer table in the second database utilizing the customer ID in the first record, utilizing the computer, the second record having the customer name;
retrieving the third record from the sales representative table in the second database utilizing a sales representative ID from the first record, utilizing the computer, the third record having a sales representative telephone number, the sales representative ID being associated with a sales representative;
inserting the customer name into the open order template message utilizing the computer;
generating a second formatted message utilizing the sales representative telephone number and the open order template message, utilizing the computer; and
transmitting the second formatted message such that the second formatted message is directed to the sales representative utilizing the computer.

19. The method of claim 12, wherein the data in the second database further includes an appointment table having a third record with a customer ID, a customer appointment date, and a customer appointment time; the method further comprising:
retrieving the third record from the appointment table in the second database utilizing the customer ID, utilizing the computer;
retrieving the second record from the customer table in the second database utilizing the customer ID from the first record, utilizing the computer, the second record having the customer telephone number;
if the customer appointment date is within a predetermined number of days from a current date, then:
retrieving an appointment template message from the template table in the second database utilizing the computer;
inserting the customer appointment date, the customer appointment time, and the vehicle dealership ID in the appointment template message, utilizing the computer; and
generating the second formatted message utilizing the appointment template message and the customer telephone number, utilizing the computer.

20. The method of claim 12, further comprising:
transmitting the first formatted message to a telephone texting system, utilizing the computer; and
sending the first formatted message as a text message utilizing the customer telephone number, utilizing the telephone texting system.
